(19) United States
(12) Patent Application Publication
(10) Pub. No.: US 2010/0333023 A1
(43) Pub. Date: Dec. 30, 2010

(54) DEVICE WITH E-MAIL FUNCTION

(75) Inventors: Michiaki Koizumi, Osaka (JP); Masashi Sandaiji, Osaka (JP)

Correspondence Address: PROCOPIO, CORY, HARGREAVES & SAVITCH LLP, 525 B STREET, SUITE 2200, SAN DIEGO, CA, 92101, US

(73) Assignee: KYOCERA CORPORATION, Kyoto (JP)

(21) Appl. No.: 12/865,200

(22) PCT Filed: Jan. 22, 2009
(86) PCT No.: PCT/JP2009/051009

§ 371 Date: Jul. 29, 2010

(30) Foreign Application Priority Data
Jan. 31, 2008 (JP) 2008-022066

(51) Int. Cl. G06F 3/048

(52) U.S. Cl. 715/815

(57) ABSTRACT

[Object] To provide a device with an e-mail function that allows screen transition actions to be smoothly performed in the e-mail function.

[Constitution] When checking detailed content of mail, a user selects a desired mail title from a list and turns a jog dial 7 downward. Upon determining that the jog dial 7 is turned downward, a display control section 110 adds a mail details area R3 to an information display area R1 and shows mail content in this area. After that, if determining that the jog dial 7 is turned downward, the display control section 110 re-arranges a display area and aligns a reception screen area R4 and a replay screen area R5 in the information display area R1. Then, the display control section 110 shows text of the received mail in the reception screen area R4 and shows text of replay mail in the reply screen area R5.

### TECHNICAL FIELD

The present invention relates to devices with an e-mail function, and in particular is suitable for use in portable terminal devices such as mobile phones and personal digital assistants (PDAs).

### BACKGROUND ART

In general, portable terminal devices such as mobile phones and PDAs are equipped with a function of e-mail (hereinafter, referred to simply as “mail”). Users can view a list of received mail, select desired mail from the list, check the content of the mail, and then can create reply mail and transmit the same to the other party as necessary. For example, this kind of a portable terminal device is disclosed in Patent Document 1.

With the portable terminal device of Patent Document 1, a user moves a cursor (focus) to desired received mail on a received mail list screen and then presses and holds a side controller as an operation button for a short time. Accordingly, the device moves to a screen showing the content of the desired received mail pointed by the cursor. In addition, when the user presses down the side controller for a long time on the screen showing the content of the received mail, the device changes to a screen for transmitting a reply to the received mail on display.

Patent Document 1: JP 2004-62645 A

### DISCLOSURE OF THE INVENTION

### Problem to be Solved by the Invention

This kind of a portable terminal device can be configured such that one cabinet constitutes a main unit and includes a display on the entire front surface thereof. In this case, operation buttons may be arranged on a display surface as a touch panel, for example. Accordingly, the display surface is divided into an area for displaying a mail screen or the like and an area for displaying the operation buttons. The touch panel is arranged in the area for displaying operation buttons.

In this configuration, the front surface of the main unit enables display in the entire area. Therefore, the area for displaying a mail screen or the like and the area for displaying operation buttons are not necessarily required to be fixed in range, and the sizes of these areas can be changed as appropriate. If the area for displaying a mail screen is made larger in size, an increased amount of information can be displayed at one time, which is convenient for a user to read received mail or the like, for example. Meanwhile, if the portable terminal device is used mainly for performing various operations, the area for displaying operation buttons can be made larger with enhanced operability.

To allow the display areas to be changed in size as stated above, the device main unit needs to have an operating section such as a jog dial or the like. In this case, it is more convenient for a user if the operating section can be used to not only resize the display areas but also change contents of the mail screen and mail modes (list/reception/transmission, and the like). If the mail screen area is extended, various kinds of information can be displayed in the area. Accordingly, in particular, the device can be drastically improved in usability by changing the contents of the mail screen in accordance with an operation for extension of the mail screen area.

In light of this respect, an object of the present invention is to provide a device with an e-mail function that can modify the contents of the mail screen in response to acts of making changes to the areas of the mail screen, thereby achieving enhancement in a user's convenience.

### Means to Solve the Problem

In consideration of the foregoing issue, the present invention has the following features.

A device with an e-mail function includes a display unit, a display control section that shows a mail screen and an operation screen in alignment on the display unit, and an area changing section that changes a size of a display area on the mail screen in a direction of alignment of the mail screen and the operation screen in response to an external operation. Here, when a user selects one mail message from a mail list displayed on the mail screen and performs an extending operation to extend the display area of the mail screen through the area changing section, the display control section shows information on mail content on the mail screen.

According to the device with an e-mail function of the present invention, the mail content is displayed in conjunction with an operation of extending the mail screen, which simplifies an operation of displaying mail content. In addition, since the mail content is displayed in accordance with extension of the area, the mail screen can be smoothly assigned to the mail content display area.

In the device with an e-mail function of the present invention, the display control section can be configured to, when a user selects one mail message from the mail list displayed on the mail screen and performs the extending operation, set a mail content display area directly under the selected mail and show information on the mail content in the mail content display area.

In such a configuration, the mail content is displayed directly under the mail selected from the mail list, which makes it easy for a user to identify the mail sender while reading the mail content.

In the device with an e-mail function of the present invention, the display control section can be configured to slot the mail content display area into between the mail selected from the mail list and mail under the same.

In such a configuration, the mail content is displayed between the mail selected from the mail list and the mail under the same, which makes it easy for a user to identify the mail sender of the selected mail while reading the mail content. In addition, since the list of other mails than the mail which content is displayed is also displayed, a user can be informed of the presence or absence of any other mail message in relation to the displayed mail content (opened mail/unopened mail from the same sender and the like), for example.

The foregoing “mail list” contains not only a list of received mail but also a list of transmitted mail. In an embodiment described below, a list of received mail is shown as an equivalent to the mail list of the present invention.

In the device with an e-mail function of the present invention, the display control section can be configured to extend the mail content display area in response to the further performed extending operation.

In such a configuration, the mail content display area is extended in response to extension of the mail screen, which allows a user to view much more mail content information at one time. In general, when viewing the mail content, many key operations are not required and thus only a small number of operation keys need to be displayed. In this configuration, although the operation screen is reduced in size in accordance with extension of the mail screen, the operation screen causes no trouble in operability with such size reduction.

In the device with an e-mail function of the present invention, the display control section can be configured to, after the mail screen display area has reached a predetermined size, if the extending operation is further performed, set a mail reply screen area on the mail screen.

In such a configuration, the mail reply screen is further displayed in conjunction with the mail screen extending operation, which allows a user to shift from checking mail content to making a mail reply by a series of operations, thereby enhancing the device in operability.

In the device with an e-mail function of the present invention, the display control section can be configured to, in addition to the mail reply screen area, set the mail content display area on the mail screen and show all or some part of the mail content in the mail content display area.

In such a configuration, the mail content is displayed concurrently with the mail reply screen, which allows a user to create reply mail while checking the content of the received mail, thereby to create the reply mail in a smooth and efficient manner.

In the device with an e-mail function of the present invention, the display control section can be configured to extend the display area of the mail screen in accordance with the further performed extending operation; and after all the information on the mail content is displayed before the display area of the mail screen reaches the predetermined size, show the mail reply screen in the display area of the mail screen in response to the subsequent extending operation.

In such a configuration, the device shifts instantly to the mail reply screen without having to wait until the display area of the mail screen reaches the predetermined size, thereby enhancing the device in usability.

In the device with an e-mail function of the present invention, the display control section can be configured to, if a user performs an operation of shrinking the display area of the mail screen through the area changing section before the display area of the mail screen reaches the predetermined size, show the mail reply screen in the display area of the mail screen.

In such a configuration, the device can move from the mail content display area to the mail reply screen as appropriate according to a user's discretion, thereby enhancing the device in usability.

The device with an e-mail function of the present invention can be configured to include an advancing section for scrolling information displayed in the mail content display area. In this case, the display control section scrolls information in the mail content display area in response to an operation of the advancing section.

In such a configuration, even if all of the mail content cannot be displayed at one time in the mail content display area, the mail content can be scrolled as appropriate by an advancement operation. This allows a user to view the mail content to the end.

In the device with an e-mail function of the present invention, the display control section can be configured to show mail text and an image attached to the mail in the mail content display area.

In such a configuration, it is possible to display not only the mail text but also the attached image, which allows a user to check the mail content in more detail.

In the device with an e-mail function of the present invention, the display control section can be configured to show mail text and predetermined information in relation to the sender of the mail in the mail content display area.

In such a configuration, it is possible to display not only the mail content but also the information related to the mail sender such as address information, mail transmission/reception records, and the like. This allows a user to create reply mail while referring to such information as appropriate, thereby enhancing the device in convenience for creation of reply mail.

According to the present invention as stated above, it is possible to provide a device with an e-mail function that can modify the contents of the mail screen in response to acts of making changes to the areas of the mail screen, thereby achieving enhancement in a user's convenience.

Advantage or significance of the present invention will be further understood from the description of an embodiment below. However, the following embodiment is merely an example for carrying out the present invention, and the present invention is not limited by the following embodiment.

### BRIEF DESCRIPTION OF THE DRAWINGS

FIG. 1 is a diagram showing a configuration of a mobile phone of an embodiment;

FIG. 2 is a diagram showing examples of screen display on the mobile phone of the embodiment in a television mode and a mail mode;

FIG. 3 is a block diagram showing a circuit configuration in the mobile phone of the embodiment;

FIG. 4 is a flowchart of a series of screen transition actions from a list screen to a reply screen of the mobile phone of the embodiment in the mail mode;

FIG. 5 is a flowchart continued from FIG. 4;

FIG. 6 is a diagram showing an example of screen transition on the mobile phone of the embodiment where a screen transition action is performed;

FIG. 7 is a diagram showing an example of screen transition in the mobile phone of the embodiment where a screen transition action is performed;

FIG. 8 is a flowchart of a screen transition action on a modification 1 of the mobile phone of the embodiment;

FIG. 9 is a flowchart of a screen transition action on a modification 2 of the mobile phone of the embodiment;

FIG. 10 is a flowchart of a screen transition action on a modification 3 of the mobile phone of the embodiment;

FIG. 11 is a flowchart continued from FIG. 10;

FIG. 12 is a diagram showing an example of a screen transition on the mobile phone of the embodiment where the screen transition action is performed on modification 3, showing display of address information;

FIG. 13 is a diagram showing an example of a screen transition on the mobile phone of the embodiment where the screen transition action is performed on modification 3, showing display of address information;

FIG. 14 is a diagram showing an example of a screen transition on the mobile phone of the embodiment where the screen transition action is performed on modification 3, showing display of mail transmission/reception records; and

FIG. 15 is a diagram showing an example of a screen transition on the mobile phone of the embodiment where the screen transition action is performed on modification 3, showing display of mail transmission/reception records.

However, the drawings are intended only for description and do not limit the scope of the present invention.

### BEST MODE FOR CARRYING OUT THE INVENTION

An embodiment of the present invention will be described below with reference to the attached drawings.

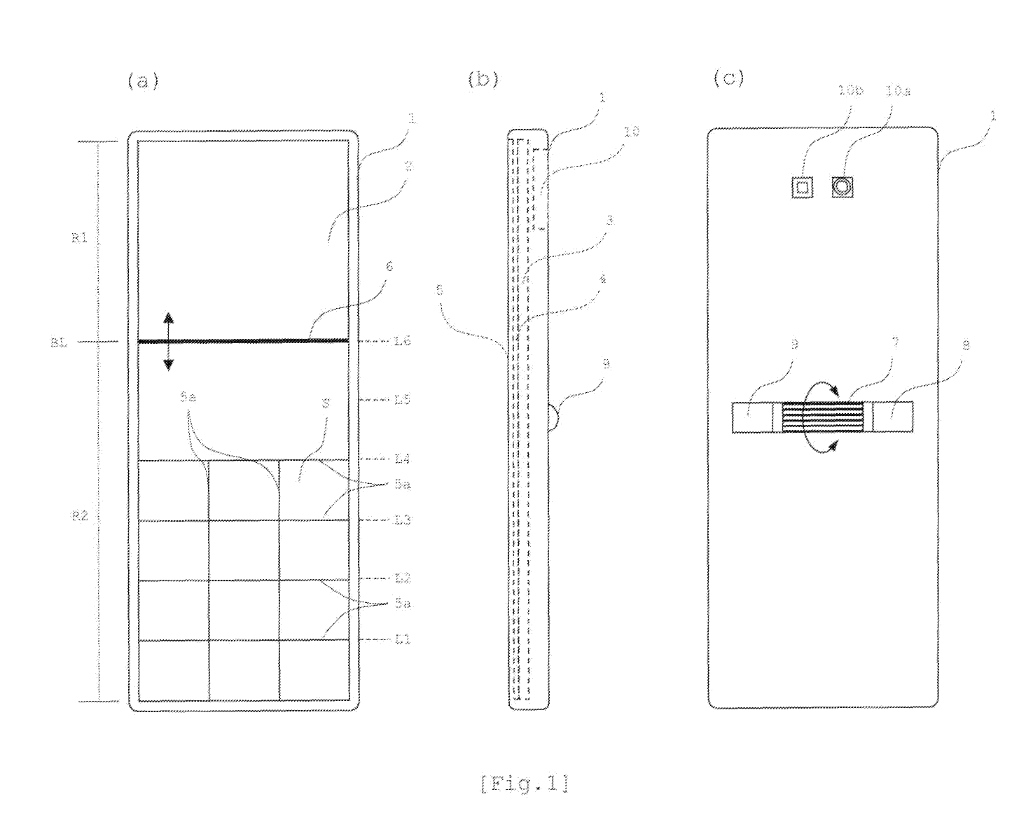

FIG. 1 is a diagram showing a configuration of a mobile phone as one embodiment of the present invention: FIGS. 1 (a), 1 (b), and 1 (c) are a front view, a right side view, and a rear view of the mobile phone, respectively.

Referring to FIG. 1, the mobile phone of this embodiment includes a cabinet 1 constituting an outer shell thereof. The cabinet 1 has the shape of a vertically-long rectangle when viewed from the front. The cabinet 1 has a display surface 2 disposed on an almost entire front surface thereof. The display surface 2 has the shape of a vertically-long rectangle as the cabinet 1 does.

The display surface 2 is formed by a liquid crystal panel 3. A touch panel 4 is arranged on a front side of the liquid crystal panel 3. The touch panel 4 is intended to detect a position pressed by a user on the display surface 2 and output a signal (position signal) corresponding to the position. A protection panel 5 arranged on a front side of the touch panel 4. The protection panel 5 is intended to protect the touch panel 4 from damage. The protection panel 5 has vertical grooves 5a and horizontal grooves 5b in a reticular pattern on a surface at a lower part thereof. These grooves 5a and 5b defines square regions S. When the square regions S are displayed with functional characters or symbols therein, the square regions S serve as individual operation keys (software keys) for performing various operations. If an operation area R2 described later is set beyond the square regions S, operation keys are shown in an area without the square regions S in such a manner that a boundary between adjacent indications of functions can be identified by enclosing the words indicative of functions with squares or the like, for example.

The display surface 2 shows a horizontal bar 6. The bar 6 divides a display area of the display surface 2 vertically into two screen areas. An area above the bar 6 constitutes an information display area R1 and an area below the same constitutes an operation area R2. The information display area R1 shows various contents such as television pictures, photographs, texts, and the like. The operation area R2 shows various operation keys. The bar 6 can be moved over the display area by operating a jog dial 7.

The jog dial 7 (corresponding to the advancing section of the present invention) is arranged at a center of the rear surface of the cabinet 1 so as to turn in upward and downward directions. When the jog dial 7 is turned in the upward direction, the bar 6 moves upward accordingly. When the jog dial 7 is turned in the downward direction, the bar 6 moves downward accordingly. In addition, the jog dial 7 can also move in forward and backward directions to act as a press button.

There are R button 8 and L button 9 on the right and left sides of the jog dial 7, respectively. The R button 8 and L button 9 can be used to perform operations for certain processing.

The cabinet 1 contains a camera module 10 at an inside upper part thereof. The camera module 10 has an imaging lens 10a and a flash section 10b exposed to outside on the rear surface of the cabinet 1.

This mobile phone can switch screens in various functional modes (telephone mode, mail mode, television mode, music mode, Internet mode, camera mode, and the like) by fixing the bar 6 at a specific position.

Accordingly, the display surface 2 has a plurality of fixed positions (for example, L1 to L6) in upward and downward directions. For example, if a user operates the jog dial 7 to move the bar 6 to a fixed position L5 and presses and holds the jog dial 7 for a short time (short-time press) with the bar 6 staying in the fixed position L5, the device shows a television mode screen. Further, if the user moves the bar 6 to a fixed position L6 and presses the jog dial 7 for a short time, the device switches from the television mode screen to a mail mode screen. In these functional mode screens, the original position of the bar 6 acts as a boundary BL between the information display area R1 and the operation area R2.

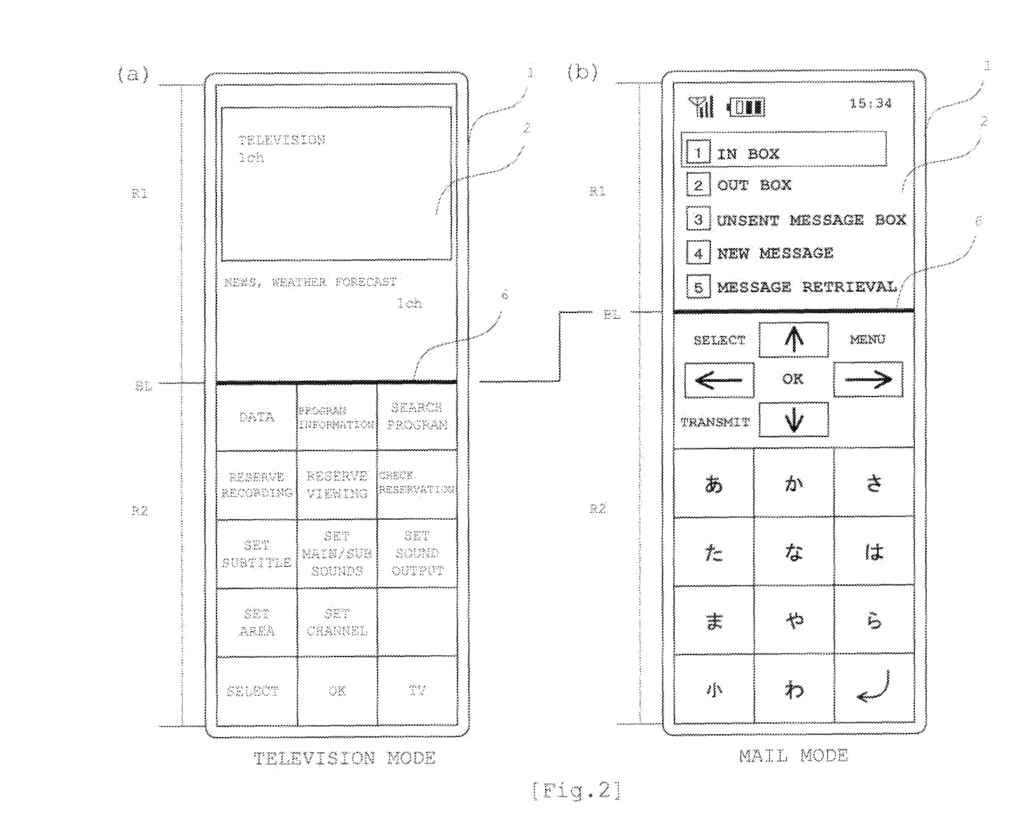

FIG. 2 (a) shows an example of screen display in the television mode. FIG. 2 (b) shows an example of screen display in the mail mode. In the television mode, as shown in FIG. 2 (a), video contents are displayed in the information display area R1, and a plurality of operation keys for performing operations in relation to video display is shown in the operation area R2. In the mail mode, an initial screen with various menu items or the like is shown in the information display area R1, and operation keys for mail creation, transmission, reception, and the like, are shown in the operation area R2.

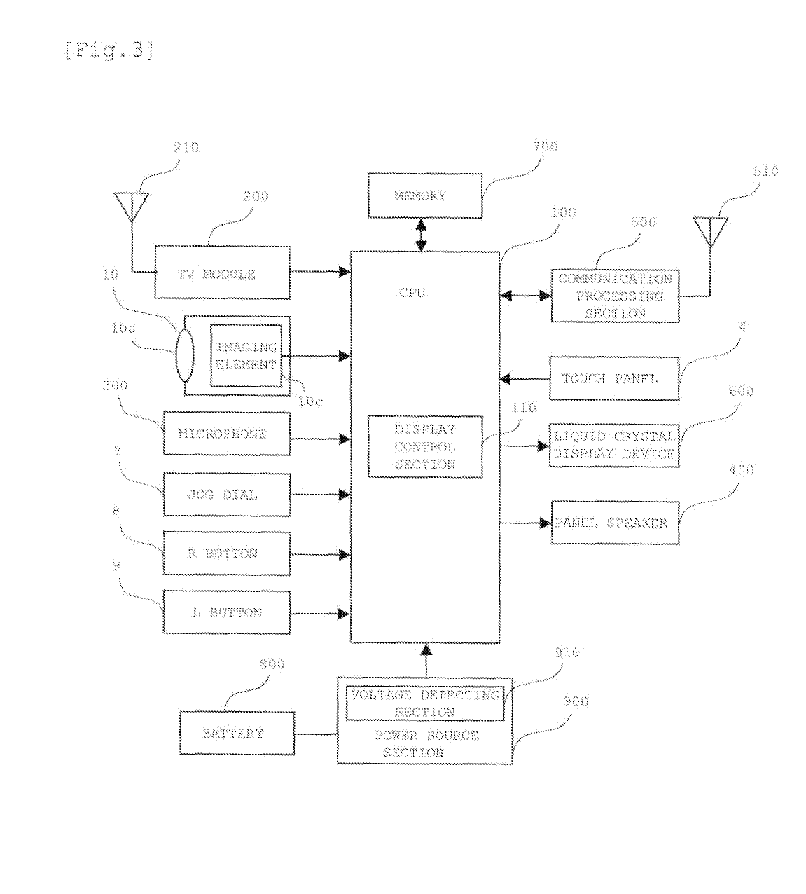

FIG. 3 is a block diagram showing a circuit configuration of the mobile phone of this embodiment. In addition to the constitutional elements described above with reference to FIG. 1, the mobile phone also includes a CPU 100, a TV module 200, a microphone 300, a panel speaker 400, a communication processing section 500, a liquid crystal display device 600, a memory 700, a battery 800, and a power source section 900.

The TV module 200 includes a TV tuner and the like, and converts radio waves such as digital terrestrial broadcast waves and analog terrestrial broadcast waves received via an antenna 210 and the like into image signals, and transmits the same to the CPU 100.

The camera module 10 includes the imaging lens 10a, the flash section 10b, and an imaging element 10c, and the like. The imaging lens 10a forms an image of an object on the imaging element 10c. The imaging element 10c is formed by a CCD, for example, and generates an imaging signal in accordance with a captured image and transmits the same to the CPU 100.

The microphone 300 converts an audio signal into an electric signal and transmits the same to the CPU 100. The panel speaker 400 reproduces the audio signal from the CPU 100 in audio representation.

The communication processing section 500 converts audio signals, image signals, text signals and the like from the CPU 100 into radio signals, and transmits the same to a base station via an antenna 510. The communication processing section 500 also converts radio signals received via the antenna 510 into audio signals, image signals, text signals and the like, and transmits the same to the CPU 100.

The liquid crystal display device 600 (corresponding to the display unit of the present invention) includes the liquid crystal panel 3 and a backlight device (not shown) as a light source of the liquid crystal panel 3, and shows an image on the liquid crystal panel 3 in accordance with a drive signal from the CPU 100.

The memory 700 saves image data shot by the camera module 10, image data captured from the outside via the communication processing section 500, text data (mail data) and the like, in predetermined file formats. In addition, the memory 700 saves video contents (television programs, movies, and the like) acquired externally via the TV module 200 or the communication processing section 500. Further, the memory 700 stores a table showing association between the fixed positions of the bar 6 and the functional modes.

The battery 800 is intended to supply power to the CPU 100 and other components of the mobile phone, and is formed by a secondary battery. The battery 800 is connected to the power source section 900.

The power source section 900 converts a voltage of the battery 800 into voltages of magnitudes required for the components of the mobile phone, and supplies the same to the components. In addition, the power source section 900 charges the battery 800 by supplying the battery 800 with power supplied from an input of an external power source (not shown). The power source section 900 has a battery voltage detecting section 910. The voltage detecting section 910 detects a voltage of the battery 800 and transmits the same to the CPU 100.

The CPU 100 outputs control signals to components such as the panel speaker 400 and the liquid crystal display device 600, in accordance with input signals from components such as the touch panel 4, the jog dial 7, the R button 8, the L button 9, the microphone 300, the imaging element 10c, and the like, to thereby perform processing in various functional modes. In addition, the CPU 100 determines a remaining level in the battery 800 in accordance with a voltage signal from the voltage detecting section 910.

The CPU 100 includes a display control section 110. The display control section 110 produces images to be displayed on the liquid crystal display device 600, in a memory (not shown) as a working area prepared in the CPU 100, and outputs image signals (RGB signals) for displaying the produced images to the liquid crystal display device 600. In addition, the display control section 110 captures image data transferred from the imaging element 10c, image data stored in the memory 700, image data (video contents) received via the TV module 200 or the communication processing section 500, and the like. Then, the display control section 110 generates image signals (RGB signals) from the captured image data, and outputs the generated image signals to the liquid crystal display device 600. Accordingly, the liquid crystal display device 600 shows the images (video pictures) in accordance with the image signals on the liquid crystal panel 3, that is, on the display surface 2.

If the jog dial 7 is operated as stated above, the CPU 100 determines an amount of operation. Then, the display control section 110 transmits an image signal based on the amount of operation, and the bar 6 is moved by the amount of operation on the display surface 2.

On the mobile phone of this embodiment in the mail mode, a user can perform smoothly a series of screen transition actions from the list screen to the replay screen, thereby to view a list of received mail, check the content of desired mail, and transmitting a replay to the received mail. The screen transition actions will be described below. As understood from the following description, the jog dial 7 and the display control section 110 implements the area changing section of the present invention.

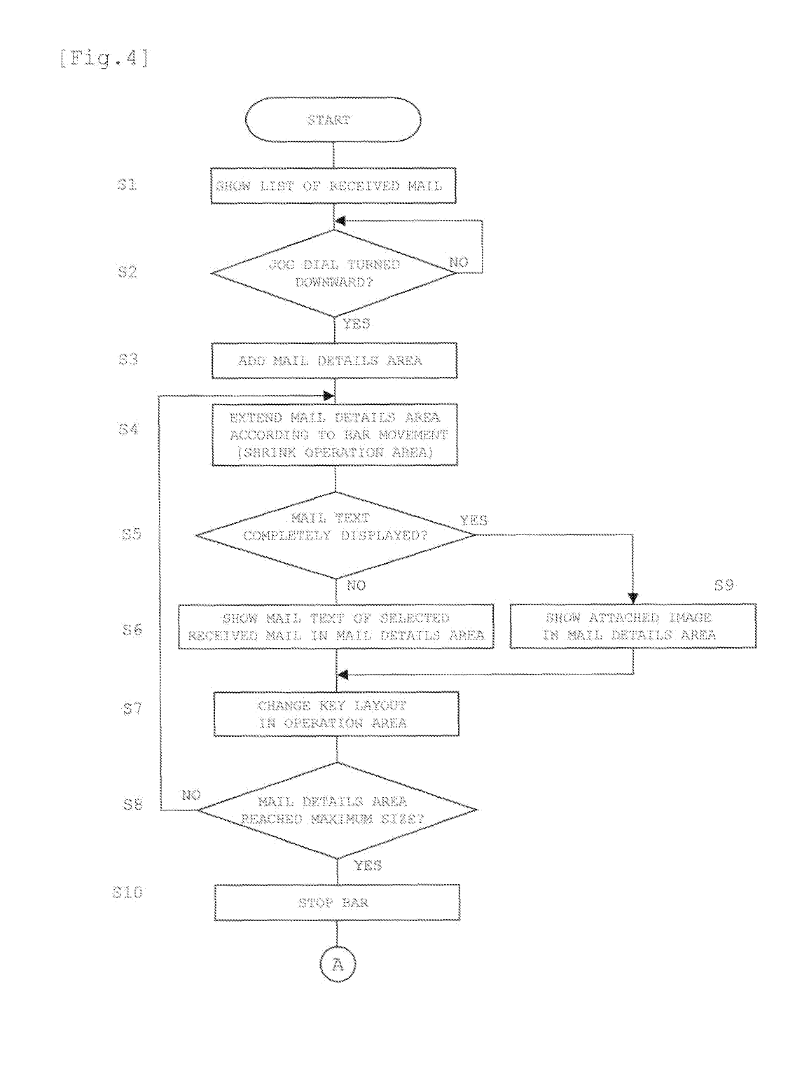

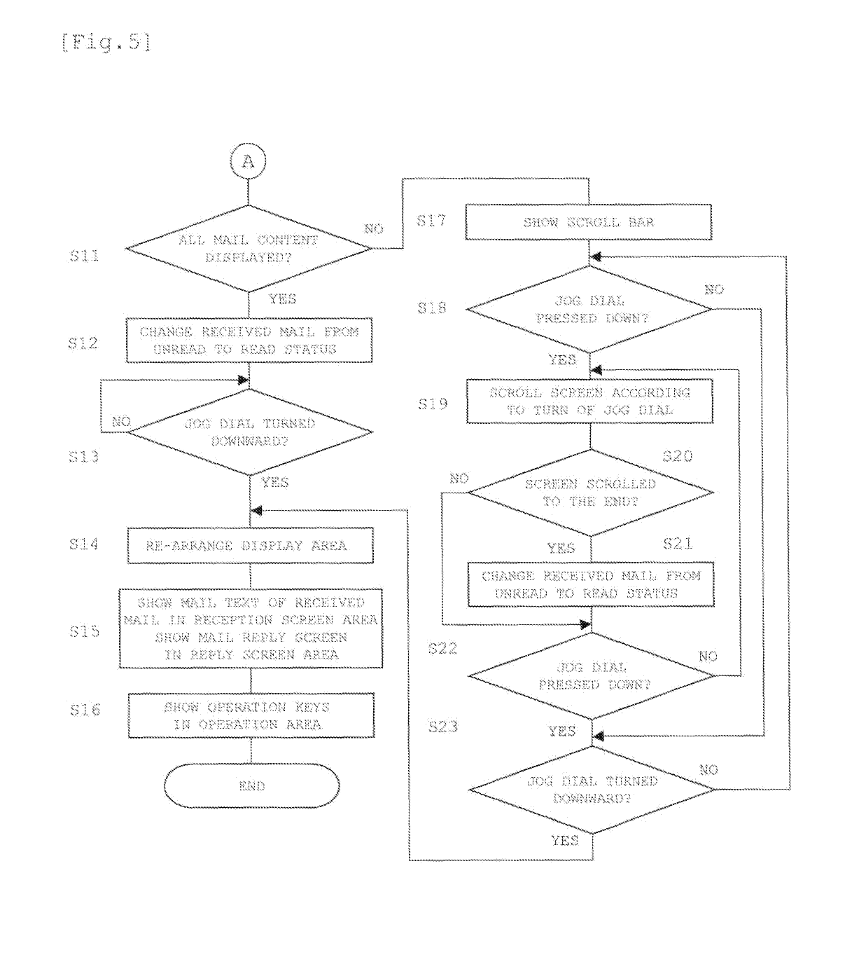

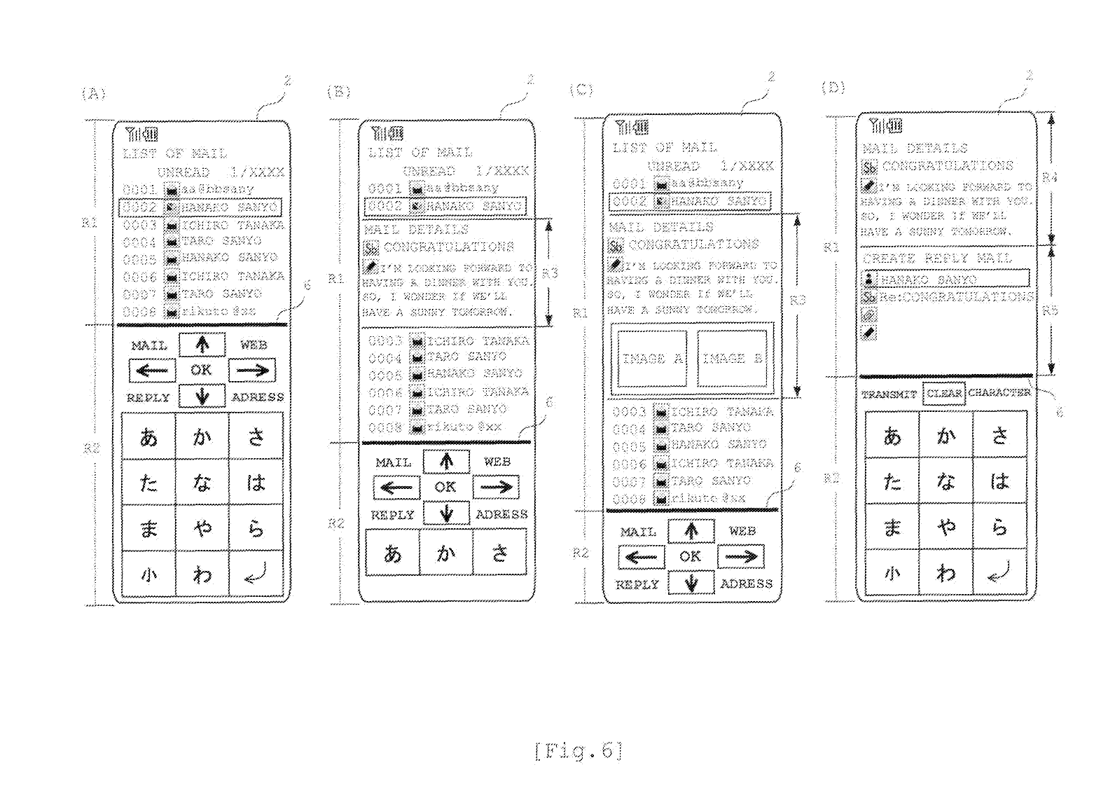

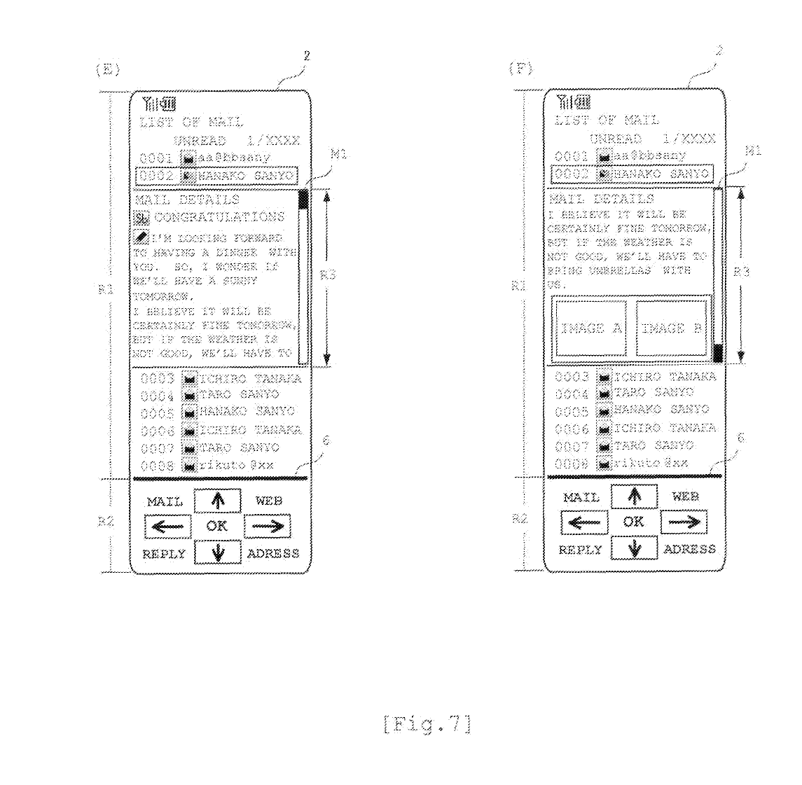

FIGS. 4 and 5 show a flowchart of the series of screen transition actions from the list screen to the reply screen in the mail mode. FIGS. 6 and 7 are diagrams showing an example of screen transitions resulting from the screen transition actions.

When a menu item of “in box” is invoked from the initial screen of the mail mode shown in FIG. 2 (b), the display control section 110 shows a list of received mail in the information display area R1 (S1: refer to FIG. 6 (A)).

For checking the detailed content of mail, a user selects a desired mail title from the list and turns the jog dial 7 downward. Upon determining that the jog dial 7 is turned downward (S2: YES), the display control section 110 performs actions of steps S3 to S10 stated below to execute a first process of displaying the mail content in the information display area R1 in response to the turning of the jog dial 7. The mail content here includes mail text and an image attached to the mail text (e.g. a photo image).

When the jog dial 7 is turned downward, the display control section 110 first adds a mail details area R3 under the selected mail title (S3). Then, the display control section 110 moves the bar 6 downward and extends the mail details area R3 in accordance with the movement of the bar 6 (S4). At that time, the operation area R2 is shrunk in accordance with the extension of the mail details area R3. The mail details area R3 corresponds to the mail content display area of the present invention.

Next, the display control section 110 determines whether the mail text is completely displayed (S5). If the mail text is not completely displayed (S5: NO), the display control section 110 shows the mail text of the selected received mail in the mail details area R3 (S6). Further, the display control section 110 changes a layout of the operation keys in accordance with the reduced size of the operation area R2 (S7: refer to FIG. 6 (B)).

The display control section 110 determines whether the mail details area R3 is extended up to a predetermined maximum size (S8). If determining that the mail details area R3 is not extended to the maximum size (S8: NO), the display control section 110 repeats the actions of steps S4 to S8. During these actions, if determining at step S5 that the mail text is completely displayed, the display control section 110 then shows an attached image subsequent to the mail text in the mail details area R3 (S9).

As foregoing, if the mail details area R3 is increasingly extended with the downward movement of the bar 6 and the display control section 110 determines that the mail details area R3 is extended up to the maximum size, the display control section 110 stops the bar 6 even if the jog dial 7 is continuously being turned downward (S10: refer to FIG. 6 (C)).

When the bar 6 is not moved, the user can understand that the mail content is displayed to the full.

Next, the display control section 110 determines whether all the mail content is displayed in the mail details area R3 (refer to FIG. 5: S11). If all the mail content is displayed, the display control section 110 changes the status of the selected received mail from unread to read, and changes a status mark on the screen from “unread” to “read” accordingly (S12).

After checking the mail content, if the user intends to transmit a reply to the mail, the user turns the jog dial 7 downward again in the state where the mail content is displayed.

Upon determining that the jog dial 7 is turned downward (S13: YES), the display control section 110 performs the actions of steps S14 to S16 stated below to execute a second process of displaying the mail reply screen in the information display area R1.

The display control section 110 first re-arranges the display area (S14). Specifically, the display control section 110 aligns the information display area R1 and the operation area R2 in the display area at a predetermined ratio. The display control section 110 further aligns a reception screen area R4 and a reply screen area R5 in the information display area R1. Then, the display control section 110 shows the mail text of the received mail in the reception screen area R4, and shows the mail reply screen in the reply screen area R5 (S15). The display control section 110 also shows the operation keys for use in transmitting reply mail in the operation area R2 (S16: refer to FIG. 6 (D)). The reception screen area R4 corresponds to the mail content display area of the present invention, and the reply screen area R5 corresponds to the mail reply screen area of the present invention.

Accordingly, the user can create reply mail while checking the content of the received mail. The user can scroll up and down the information displayed in the reception screen area R4 and the reply screen area R5 by touching the screen area with a finger and moving the finger on the screen area upward and downward, for example. This allows the user to check all the content of the received mail and the content of the reply mail.

If the mail content is large in volume due to the long mail text or the like, all the mail content cannot be displayed in the mail details area R3 in the state of FIG. 6 (C). In this case, the display control section 110 determines that all the mail content is not displayed at step S11. Accordingly, the display control section 110 shows a scroll bar M1 in the mail details area R3 (S17: refer to FIG. 7 (E)).

When the scroll bar M1 appears, the user can understand easily that the mail continues. If the user wishes to view the continued part of the mail, the user presses down the jog dial 7 and turns the jog dial 7 to scroll the screen.

Upon determining that the jog dial 7 is pressed down (S18: YES), the display control section 110 scrolls the mail content in accordance with the turn of the jog dial 7 (S19). Then, upon determining that the screen is scrolled down to the end and all the mail content is displayed (S20: YES), the display control section 110 changes a status of the selected received mail from unread to read, and changes a status mark on the screen from “unread” to “read” (S21). Accordingly, the user can check the mail content to the end (refer to FIG. 7 (F)).

The display control section 110 determines whether the jog dial 7 is further pressed down (S22). If determining that the jog dial 7 is further pressed down (S22: YES), the display control section 110 cancels the mode of scroll operation. Then, the display control section 110 determines whether the jog dial 7 is turned downward (S23). If determining that the jog dial 7 is turned downward (S23: YES), the display control section 110 moves to step S14 described above.

If the user turns the jog dial 7 upward during the actions of steps S3 to S10, it is preferred that the mail details area R3 is shrunk in accordance with the turn, and the screen reverts to the initial list of received mail when the bar 6 is returned to the initial position. In addition, if the user performs a specific return operation such as turning the jog dial 7 upward in the state where the mail reply screen is displayed as shown in FIG. 6 (D), it is preferred that the screen reverts to the list of received mail as shown in FIG. 6 (A).

In this embodiment, as stated above, the mail content is displayed in the information display area R1 in conjunction with the extending operation of the information display area R1 (the display area of the mail screen) by (downward turning of) the jog dial 7, which allows the user to view the mail content in smooth and simplified operations. In addition, after the display of the mail content, the mail reply screen is displayed in the information display area R1 in response to the subsequent transition operation of the information display area R1 (downward turning), which allows the user to transmitting reply mail in simplified operations after viewing the received mail. Accordingly, when checking the content of the desired mail and transmitting reply mail, the user can perform a series of screen transition actions from the mail list screen to the mail reply screen only by turning the jog dial 7 downward.

In addition, in this embodiment, the mail reply screen is displayed together with the received mail text, which allows the user to create reply mail while checking the content of the received mail text. Accordingly, the user can transmit and receive mail smoothly. Moreover, the mail reply screen shows the received mail text but does not include an attached image. Accordingly, the mail reply screen and the operation keys can be displayed in a larger screen area to thereby allow the user to create reply mail smoothly.

In checking the content of mail, many operations are not required and therefore the operation keys can be decreased in number and the operation area R2 can be reduced in size. Considering this matter in this embodiment, the operation area R2 is shrunk as the information display area R1 is extended by an extending operation with the jog dial 7. Accordingly, the mail content can be displayed in as a larger area as possible with efficient use of the operation area R2, thereby making it easy for the user to check the mail content.

Further, in this embodiment, the display shows not only the mail text but also the attached image in the mail details area R3, which allows a user to check the mail content in more detail.

Further, even if the mail content cannot be displayed in the mail details area R3 at one time, the mail content can be advanced through a scroll operation, which allows a user to check the mail content to the end. In this case, all the user needs to do is press down the jog dial 7 that has been operated until now, without having to operate any other button. This allows the user to check the mail without deterioration of operability.

Although the embodiment of the present invention is as described above, the present invention is not limited to this embodiment. In addition, the embodiment of the present invention can be appropriately modified in various manners within the scope of a technical idea recited in the claims. For example, the embodiment may be modified as described below.

### Modification 1

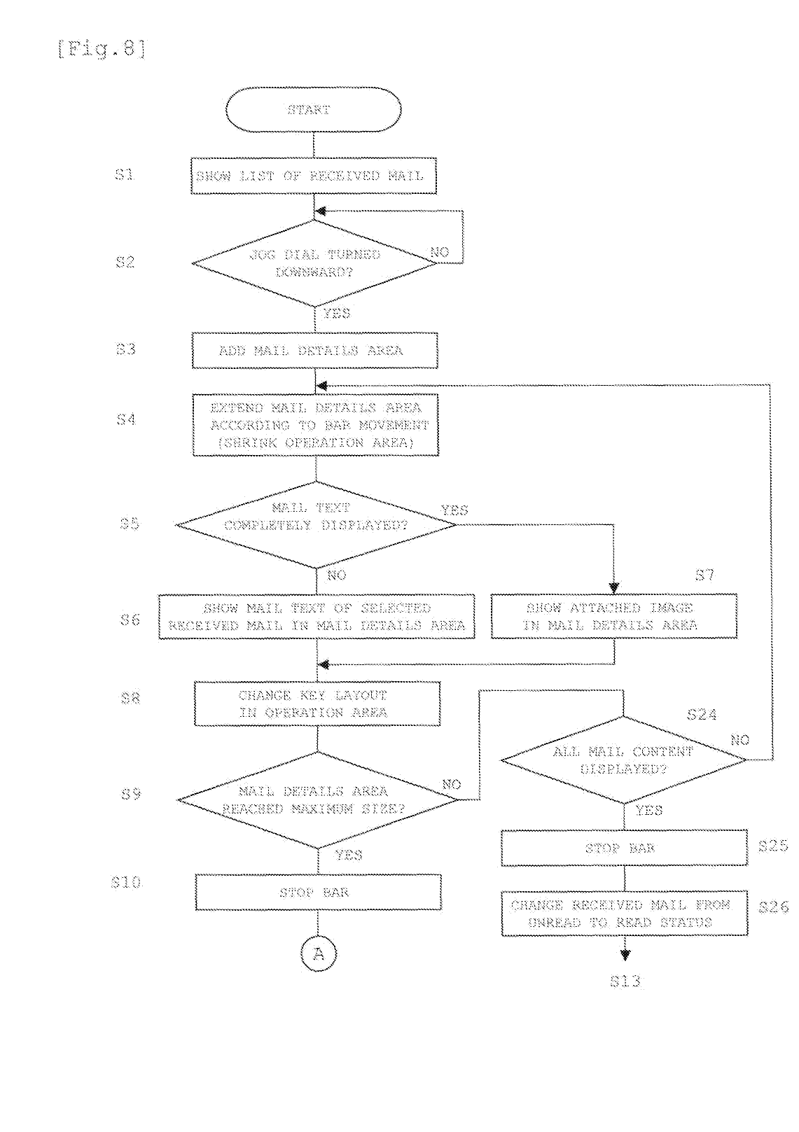

FIG. 8 is a flowchart of screen transition actions in modification 1. In this example, actions of steps S24 to S26 are added to the flowchart in the foregoing embodiment shown in FIG. 5. In other parts, this flowchart is identical to the flowchart in the foregoing embodiment.

In this example, if determining at step S9 that the mail details area R3 has not reached a maximum size, the display control section 110 then determines whether all the mail content is displayed at this point of time, that is, before the mail details area R3 reaches the maximum size (S24). Upon determining that all the mail content is displayed (S24: YES), the display control section 110 stops the bar 6 (S25). The display control section 110 further changes a status of the selected received mail from unread to read (S26), and then moves to step S13.

In such a configuration, once all the mail content is displayed, the user can make a shift immediately to the mail reply screen without having to wait until the mail details area R3 reaches the maximum size, thereby achieving enhancement in usability.

### Modification 2

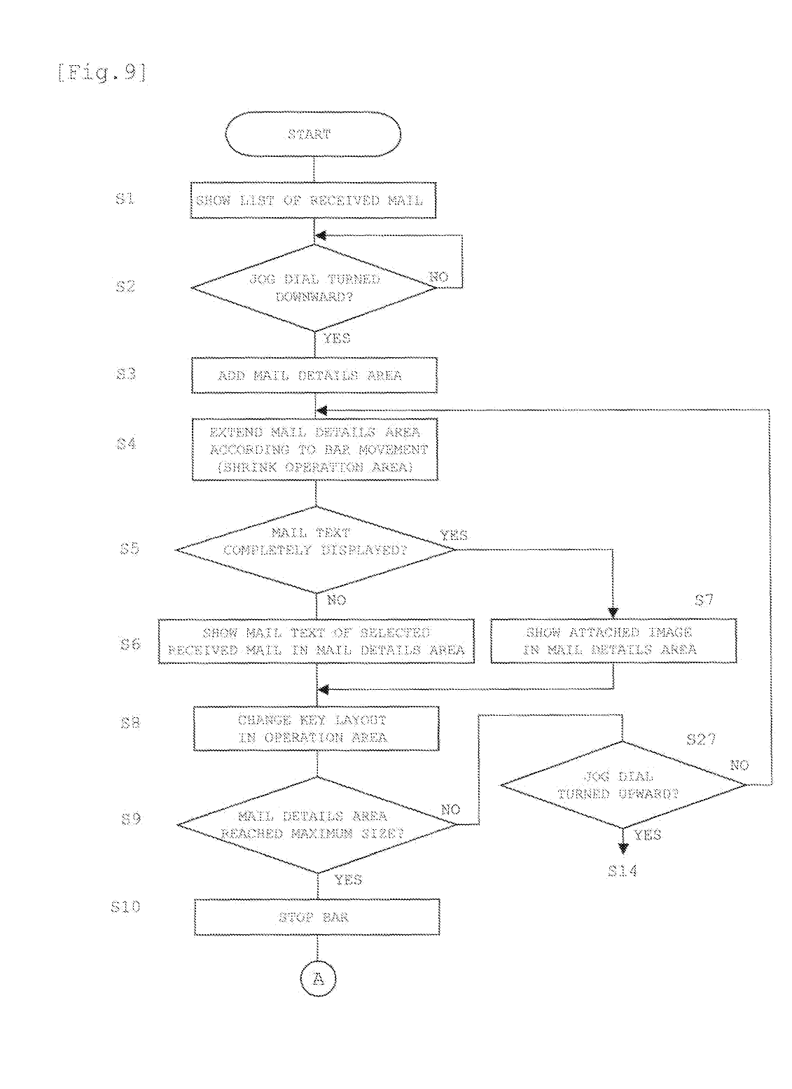

FIG. 9 is a flowchart of screen transition actions in modification 2. In this example, an action of step S27 is added to the flowchart in the foregoing embodiment shown in FIG. 5. In other parts, this flowchart is identical to the flowchart in the foregoing embodiment.

In this example, before the display control section 110 determines at step S9 that the mail details area R3 has reached the maximum size, if the user turns the jog dial 7 upward and the display control section 110 determines that the jog dial 7 is turned upward (S27: YES), the display control section 110 moves instantly to step S14 to start the second process of showing the mail reply screen.

In such a configuration, the user can stop checking the mail content in midstream and moves quickly to the mail reply screen if necessary, whereby achieving enhancement in usability.

### Modification 3

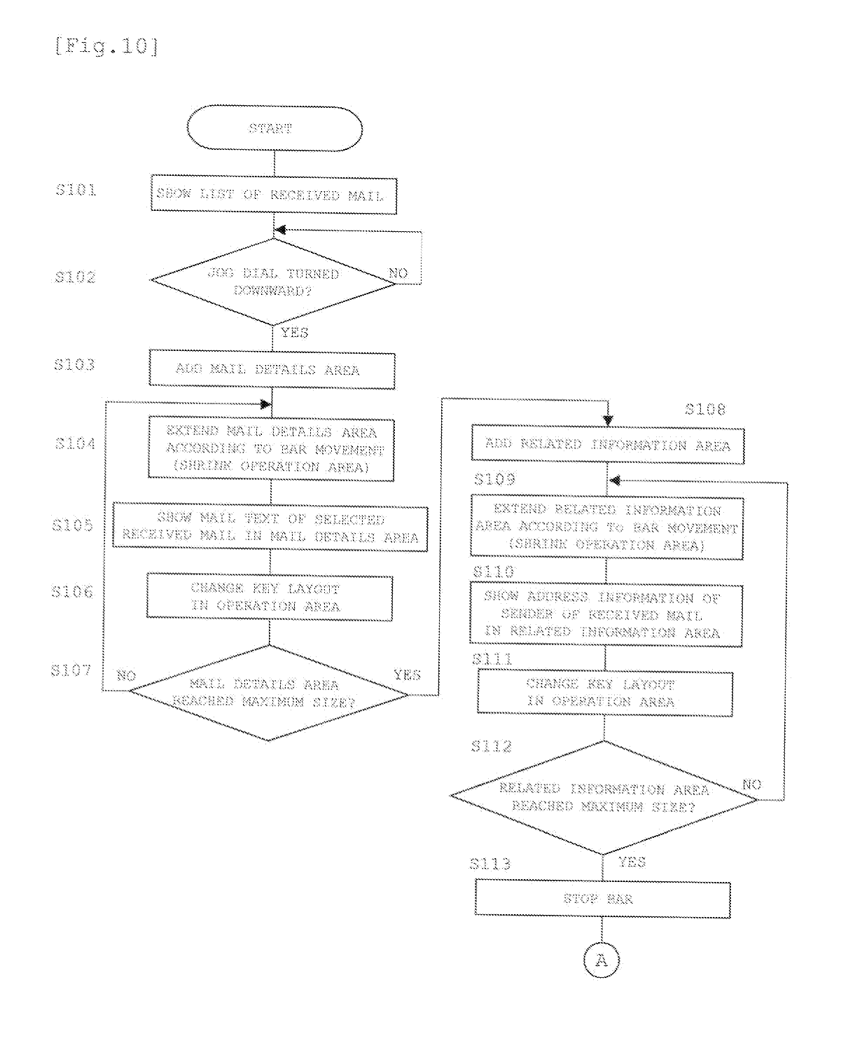

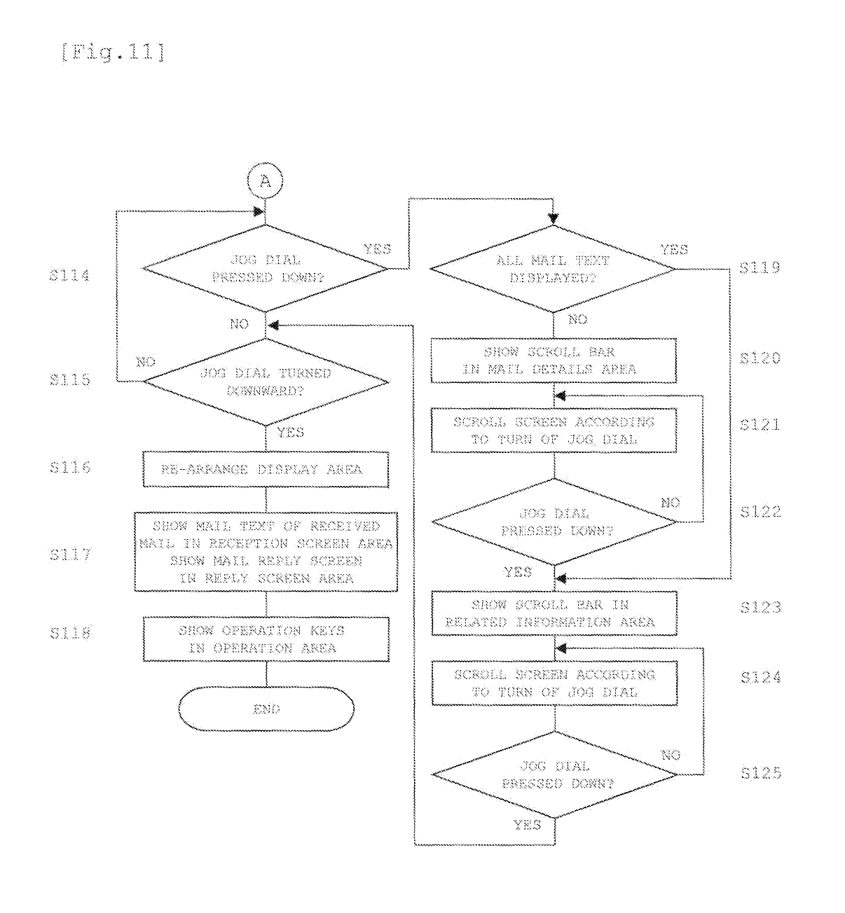

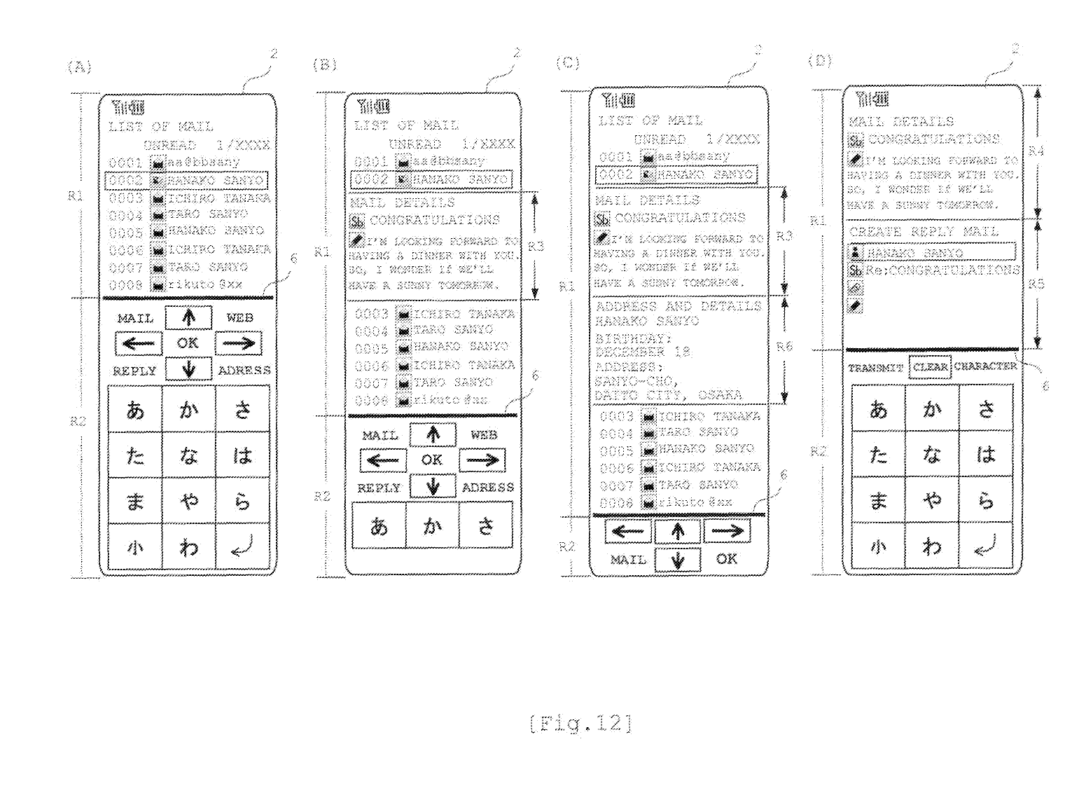

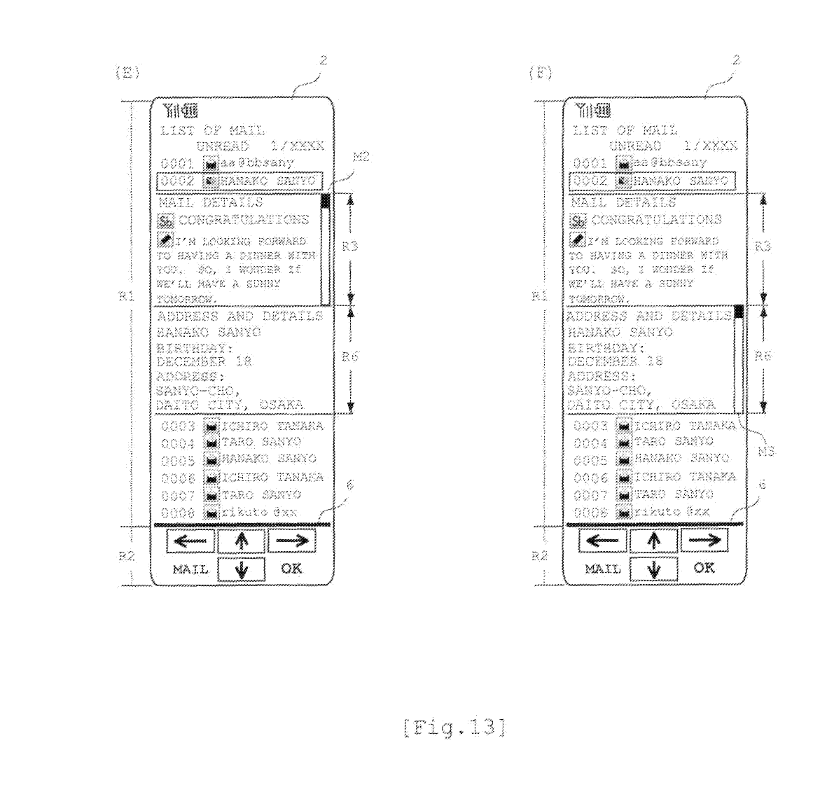

FIGS. 10 and 11 show a flowchart of screen transition actions in modification 3. FIGS. 12 and 13 are diagrams showing an example of screen transitions where the screen transition actions in modification 3 are carried out.

In this example, in addition to the mail text of the received mail, images indicative of information on the received mail are also displayed. For example, address information of the mail sender is displayed.

First, when the list of received mail is displayed as shown in FIG. 12 (A) (S101), if the user turns the jog dial 7 downward (5102: YES), the display control section 110 executes actions of steps S103 to S107 as a first process.

Specifically, the display control section 110 adds the mail details area R3 under the selected mail title (S103). Then, the display control section 110 moves the bar 6 downward to extend the mail details area R3 in accordance with the movement of the bar 6 (S104). At that time, the operation area R2 is shrunk in accordance with the extension of the mail details area R3. Next, the display control section 110 shows the mail text of the selected received mail in the mail details area R3 (S105). The display control section 110 further changes a layout of the operation keys in accordance with the reduced size of the operation area R2 (S106: refer to FIG. 12 (B)).

The display control section 110 repeats the actions of steps S104 to S107 until determining at step S107 that the mail details area R3 has reached the maximum size. Upon determining at step S107 that the mail details area R3 has reached the maximum size, the display control section 110 further executes actions of steps S108 to S112 as the first process. Specifically, the display control section 110 adds a related information area R6 under the mail details area R3 (S108), and extends the related information area R6 in accordance with the movement of the bar 6 (S109). At that time, the operation area R2 is further shrunk in accordance with the extension of the related information area R6. Next, the display control section 110 shows address information of the mail sender in the related information area R6 (S110). The display control section 110 further changes a layout of the operation keys in accordance with the reduced size of the operation area R2 (S111: refer to FIG. 12 (C)).

Until determining at step S112 that the related information area R6 has reached the maximum size, the display control section 110 repeats the actions of steps S109 to S112. Upon determining at step S112 that the related information area R6 has reached the maximum size, the display control section 10 stops the bar 6 (S113). An area formed by the mail details area R3 and the related information area R6 corresponds to the mail content display area of the present invention.

Accordingly, the user can check the mail content and the address information of the mail sender.

Next, the display control section 110 determines whether the jog dial 7 is pressed down (S114). If the jog dial 7 is not pressed down (S114: NO), the display control section 110 then determines whether the jog dial 7 is turned downward (S115). Upon determining that the jog dial 7 is pressed down (S115: YES), the display control section 110 executes actions of steps S116 to S118 as a second process.

The display control section 110 first re-arranges the display area (S116). Specifically, the display control section 110 aligns the information display area R1 and the operation area R2 in the display area at a predetermined ratio. The display control section 110 further aligns a reception screen area R4 and a reply screen area R5 in the information display area R1. Then, the display control section 110 shows the mail text of the received mail in the reception screen area R4, and shows the mail reply screen in the reply screen area R5 (S117). The display control section 110 also shows the operation keys for use in transmitting reply mail in the operation area R2 (S118: refer to FIG. 12 (D)).

Meanwhile, if determining at step S114 that the jog dial 7 is pressed down, the display control section 110 then determines whether all the mail text is displayed in the mail details area R3 (S119). If determining that all the mail text is not displayed (S119: NO), the display control section 110 shows a scroll bar M2 in the mail details area R3 (S120). Then, when the user turns the jog dial 7, the display control section 110 scrolls the mail text in accordance with the turning (S121: refer to FIG. 13 (E)).

Subsequently, if determining that the jog dial 7 is further pressed down (S122: YES), the display control section 110 erases the scroll bar M2 from the mail details area R3 and shows a scroll bar M3 in the related information area R6 (S123). Then, when the user turns the jog dial 7, the display control section 110 scrolls the address information in accordance with the turning (S124: refer to FIG. 13 (F)).

If the display control section 110 determines at step S119 that all the mail text is displayed, the mail text does not need to be scrolled, and therefore the display control section 110 shows instantly the scroll bar M3 in the related information area R6.

Accordingly, the user can check the mail text and the address information to the end.

The display control section 110 further determines whether the jog dial 7 is further pressed down (S125). If determining that the jog dial 7 is pressed down (S125: YES), the display control section 110 cancels the mode of scroll operation and then moves to step S115.

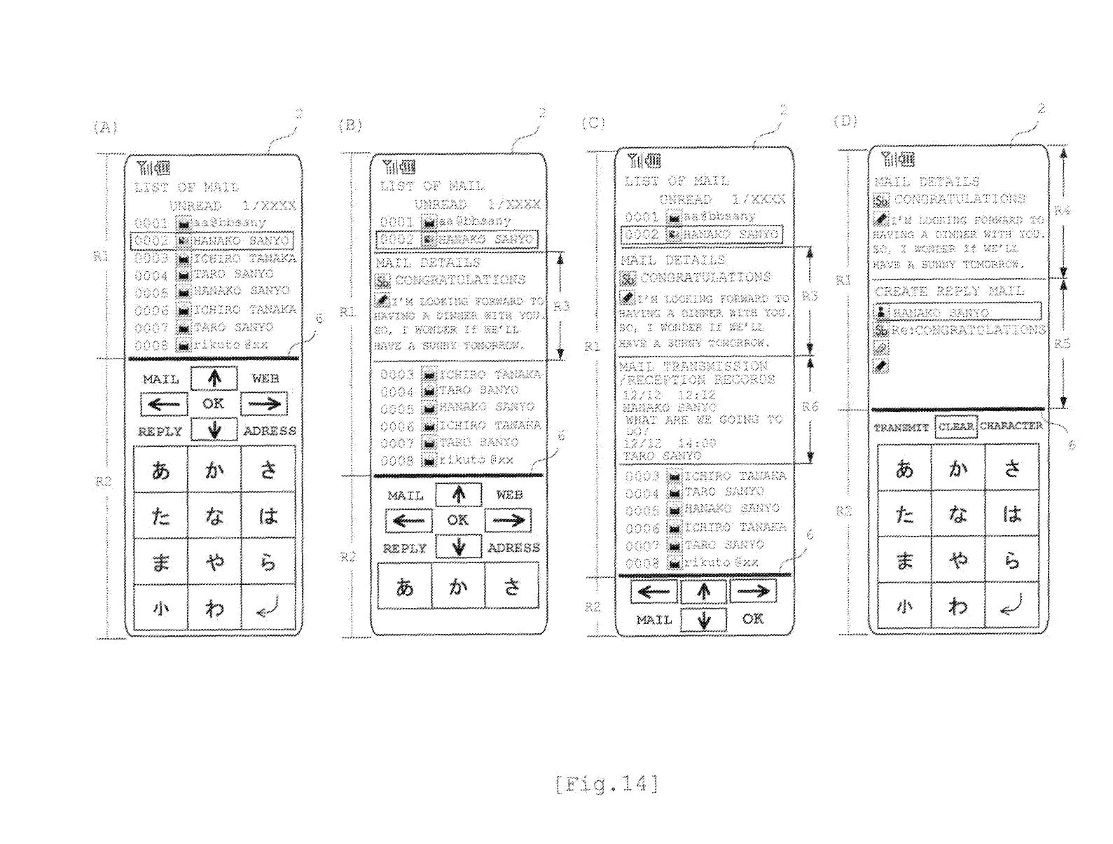

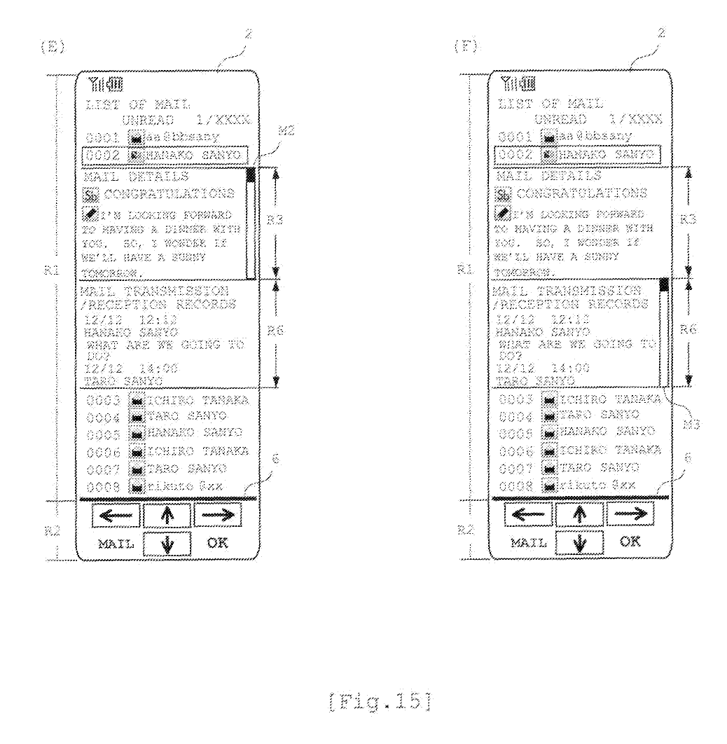

In this example, instead of the address information of the mail sender, mail transmission/reception records in relation to the selected received mail may be displayed in the related information area R6 as shown in FIGS. 14 and 15. In this example, an attached image may also be displayed in the mail details area R3 as in the foregoing embodiment. Further, the actions described in relation to the foregoing modifications 1 and 2 may be added to this example.

In the configuration of modification 3, since not only the mail content but also specific information in relation to the mail sender such as address information, mail transmission/reception records, and the like, are displayed, the user can create reply mail with reference to the information with enhanced convenience. In addition, in the second process, the mail text is displayed but the specific information in relation to the mail sender is not displayed, and therefore the mail reply screen and the operation key screen area can be made larger in size, which allows the user to create reply mail smoothly.

### Others

In the configurations of the foregoing embodiment and modification 3, the user switches the functions of the jog dial 7 and turns the jog dial 7 to scroll (advance) the mail content and the address information. However, the present invention is not limited by these configurations, and may be configured in such a manner that the user scrolls the mail content and the address information with the use of the touch panel 4 to touch the mail details area R3 or the related information area R6 with a finger and move the finger in the area upward or downward. Alternatively, the present invention may be configured in such a manner that the user scrolls the same with the use of the operation key in the operation area R2. However, if the mail content and the address information can be scrolled (advanced) with the jog dial 7 as described above, there is no need to operate any other button, whereby the device is less prone to be deteriorated in operability.

Further, in the foregoing embodiment, after the mail details area R3 has reached the maximum size, the jog dial 7 can be pressed down to scroll the mail content. Alternatively, the present invention may be configured in such a manner that, if all the mail content is not displayed even after the mail details area R3 has reached the maximum size, the user can further turn the jog dial 7 downward to scroll the mail content; and when the mail content is scrolled to the end, the user can further turn the jog dial 7 downward to display the mail reply screen.

Besides, the embodiments of the present invention can be modified in various manners as appropriate within the scope of a technical idea shown in the claims.

What is claimed is:

1. A device with an e-mail function, comprising:
a display unit;
a display control section that shows a mail screen and an operation screen in alignment on the display unit; and
an area changing section that changes a size of a display area on the mail screen in a direction of alignment of the mail screen and the operation screen in response to an external operation, wherein
when a user selects one mail message from a mail list displayed on the mail screen and performs an extending operation to extend the display area of the mail screen through the area changing section, the display control section shows information on mail content on the mail screen.

2. The device with an e-mail function according to claim 1, wherein
when a user selects one mail message from the mail list displayed on the mail screen and performs the extending operation, the display control section sets a mail content display area directly under the selected mail and shows information on the mail content in the mail content display area.

3. The device with an e-mail function according to claim 2, wherein
the display control section slots the mail content display area into between the mail selected from the mail list and mail under the same.

4. The device with an e-mail function according to claim 2, wherein
the display control section extends the mail content display area in response to the further performed extending operation.

5. The device with an e-mail function according to claim 1, wherein
after the mail screen display area has reached a predetermined size, if the extending operation is further performed, the display control section sets a mail reply screen area on the mail screen.

6. The device with an e-mail function according to claim 5, wherein
in addition to the mail reply screen area, the display control section sets the mail content display area on the mail screen and shows all or some part of the mail content in the mail content display area.

7. The device with an e-mail function according to claim 5, wherein
the display control section extends the display area of the mail screen in accordance with the further performed extending operation; and after all the information on the mail content is displayed before the display area of the mail screen reaches the predetermined size, shows the mail reply screen in the display area of the mail screen in response to the subsequent extending operation.

8. The device with an e-mail function according to claim 5, wherein
if a user performs an operation of shrinking the display area of the mail screen through the area changing section before the display area of the mail screen reaches the predetermined size, the display control section shows the mail reply screen in the display area of the mail screen.

9. The device with an e-mail function according to claim 2, further comprising an advancing section for scrolling information displayed in the mail content display area, wherein
the display control section scrolls information in the mail content display area in response to an operation of the advancing section.

10. The device with an e-mail function according to claim 2, wherein
the display control section shows mail text and an image attached to the mail in the mail content display area.

11. The device with an e-mail function according to claim 2, wherein
the display control section shows mail text and predetermined information in relation to the sender of the mail in the mail content display area.
